(19) United States
(12) Patent Application Publication
(10) Pub. No.: US 2011/0179161 A1
(43) Pub. Date: Jul. 21, 2011

(54) AGGREGATION OF SOCIAL NETWORK DATA

(75) Inventors: Ido Guy, Kiryat Ata (IL); Inbal Ronen, Haifa (IL); Sigalit Ur, Misgav (IL)

(73) Assignee: International Business Machines Corporation, Armonk, NY (US)

(21) Appl. No.: 12/691,318

(22) Filed: Jan. 21, 2010

(51) Int. Cl. G06F 15/16

(52) U.S. Cl. 709/224

(57) ABSTRACT

A method, system, and computer program product for aggregation of social network data on a user's local system are provided. The system at the user's local system includes: a processor; a private social network data collector for collecting private social network data relating to a user from applications on a user's local system; a receiver for receiving public social network data at the user's local system; and a local aggregator for combining the private social network data with the public social network data on the user's local system. The combined private and public social network data is only accessible by or with the permission of the user on the user's local system. The receiver may receive aggregated public social network data relating to the user from a public aggregator on a server system, wherein the aggregated public social network data is collected from public sources.

### BACKGROUND

This invention relates to the field of social network data. In particular, the invention relates to aggregation of social network data from private and public sources.

Social network data is prevalent in both publicly-available and private stores. Potential sources of social information are very diverse. Different users make use of different tools, and social information is scattered among many services and applications. As these applications rarely interoperate, each is typically only aware of its own social data and cannot benefit from other applications' data.

Examples in which social network data arises range from blogs (Web logs) and wikis (collections of web pages designed to enable anyone who accesses it to contribute or modify content) through recommender systems to social bookmarking and personal network systems. In continuation of its dominance on the internet, social network data has emerged in organizations, as a mean of connecting employees in a better way and enhancing knowledge management and expertise location.

Existing social network software often presents either public or private data, but does not integrate the data, although the character of the data is similar, due to a potential loss of privacy of the private data.

One approach in which the public and private data is integrated requires the user to voluntarily grant access to her private data. In this case, the loss of privacy is a major drawback.

### BRIEF SUMMARY

According to a first aspect of the present invention there is provided a method for aggregation of social network data, comprising: collecting private social network data relating to a user from applications on a user's local system; receiving public social network data at the user's local system; and combining the private social network data with the public social network data on the user's local system; wherein the combined private and public social network data is only accessible by or with the permission of the user on the user's local system; wherein said steps are implemented in either: a) computer hardware configured to perform said identifying, tracing, and providing steps, or b) computer software embodied in a non-transitory, tangible, computer-readable storage medium.

According to a second aspect of the present invention there is provided a computer program product for aggregation of social network data, the computer program product comprising: a computer readable storage medium having computer readable program code embodied therewith, the computer readable program code comprising: computer readable program code configured to: collect private social network data relating to a user from applications on a user's local system; receive public social network data at the user's local system; and combine the private social network data with the public social network data on the user's local system; wherein the combined private and public social network data is only accessible by or with the permission of the user on the user's local system.

According to a third aspect of the present invention there is provided a system for aggregation of social network data on a user's local system, comprising: a processor; a private social network data collector for collecting private social network data relating to a user from applications on a user's local system; a receiver for receiving public social network data at the user's local system; a local aggregator for combining the private social network data with the public social network data on the user's local system; wherein the combined private and public social network data is only accessible by or with the permission of the user on the user's local system.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIGS. 1A and 1B are schematic diagrams illustrating aggregating social network data in accordance with the present invention;

FIG. 2 is a block diagram of a system in accordance with the present invention;

FIG. 3 is a block diagram of a computer system in which the present invention may be implemented; and

FIGS. 4A and 4B are flow diagrams of methods in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

A method, system and computer program product are described in which publicly-available social network data is combined on a client desktop with local private social network data. Thus, private data need not be exposed outside the desktop, but can be integrated locally with public data to show a complete social network.

Social network information resides both in the public domain in repositories on the internet and the intranet, and on the user's desktop. Publicly available data is known to be collected and aggregated by a public aggregator, which runs on any server. The described system provides a local aggregator, running on the user's desktop, which collects and aggregates private data, then combines it with public data collected directly or by a public aggregator to form a complete social network. Private data never leaves the desktop.

A public aggregator enables information to be gathered from different social network sources relating to the strength of relationships between contacts. The gathered information is aggregated with weightings being given to different sources. The described local aggregator running on a user's desktop additionally aggregates the user's private data. The resulting aggregated relationship strengths can be used in various applications, including weighting the results of social networks which are not weighted themselves.

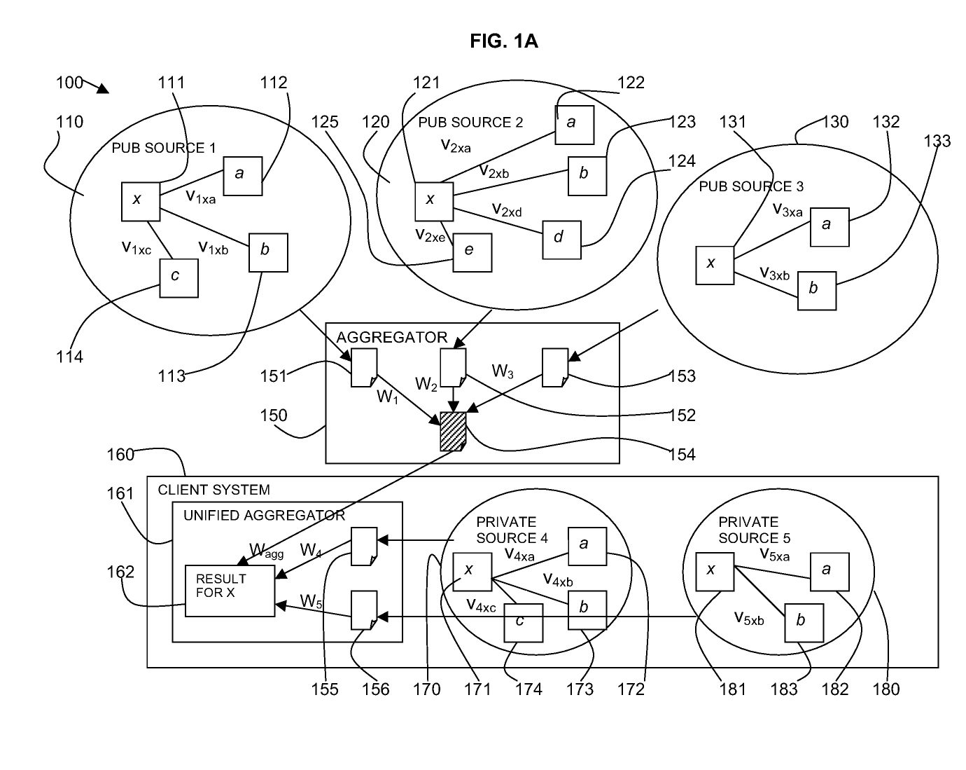

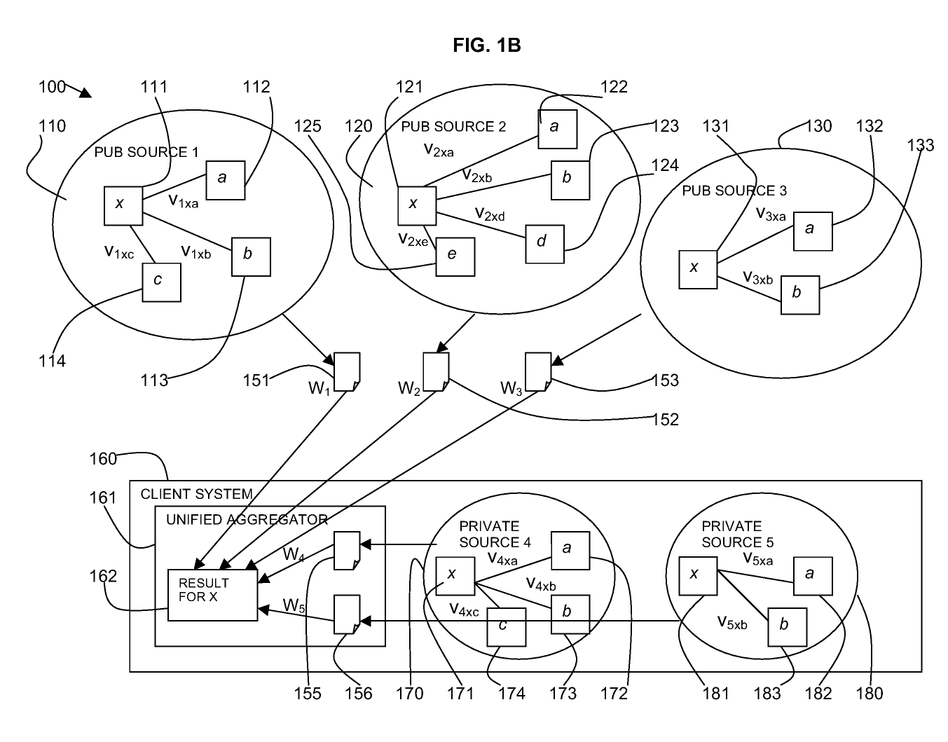

Referring to FIG. 1A, a schematic diagram 100 shows a first embodiment of aggregating public and private data including a public aggregator and a local aggregator. Three public sources 110-130 of social network data are shown. For example, the public sources 110-130 may be any public social network data source that can provide information about how strongly people are connected and, optionally, by what means. Such public sources 110-130 may include, for example: blogs (web logs); wikis (collections of web pages designed to enable anyone who accesses it to contribute or modify content); friending applications; social tagging networks; social network services; publication or patent repositories; and organizational charts.

The public sources 110-130 have contacts with connections to other contacts. In the illustrated embodiment, source 110 has contact x 111 with connections to contacts a, b, c 112-114, source 120 has contact x 121 with connections to contacts a, b, d, e 122-125, source 130 has contact x 131 with connections to contacts a, b 132-133. Connections can sometimes be directed, so contact x may be connected to contact a who is not connected to contact x.

A contact is usually a person, but as identities are defined electronically by users, it is possible that a contact may be a group of more than one person. Conversely, a person may be represented by more than one contact. For example, a family may have a single entity as an email address, or a person may have more than one user identity.

Connections may be un-weighted and simply indicate a link between contacts, or connections may have relationship weights or strengths. For example, a relationship strength is defined as vₛᵢⱼ for source s, for the connection from contact i to contact j. It should be noted that relationship strengths can be directional, for example, vₛᵢⱼ does not have to be equal to vₛⱼᵢ. In the illustrated example in FIG. 1A, the three public sources 110-130 have connections with relationship strengths.

Out of each public source 110-130, a weighted list 151-153 of connected contacts is extracted for each contact. This can be done, for example, by creating a graph of relationships for all involved contacts or by keeping a separate list of relationships for each contact. Each source 110-130 defines the strength of relationships of connected contacts according to its own semantics.

For example, the source of co-authorship of papers could take into consideration the number of common papers of two contacts and how many contacts co-authored each paper with them. A blogging system could define the strength according to whether they commented on each others' blogs and how often. In general, the following factors among others can influence the weight computation for connections between contacts:
Number of common interactions.
Number of total interactions of each person.
Number of participants in each interaction.
Time span of interaction.
Symmetry of interaction.
Reciprocity of interaction.
Sentiment of interaction—whether it is a positive or negative interaction. A negative interaction (relationship) could make the weight lower.
Density of interaction—for example, the length of the time between interactions.
Age of the interaction—how long ago the interaction happened, the longer ago, the lower the weight.

A source's contacts' relationship strengths may be defined as vₛᵢⱼ for a relationship strength between contact i and contact j at source s. In the illustrated example:
Source 110 has relationship strengths for contact x of: v₁ₓₐ, v_{1xb}, v_{1xc};
Source 120 has relationship strengths for contact x of: v₂ₓₐ, v_{2xb}, v_{2xd}, v₂ₓₑ;
Source 130 has relationship strengths for contact x of: v₃ₓₐ, v_{3xb}.

A public aggregator 150 extracts the weighted lists 151-153 of relationship strengths of connections for a contact x from each public source 110-130, as given above. The public aggregator creates an aggregated weighted contacts list 154 in the form an aggregation of relationship strengths of connections for the contact x from multiple public sources.

In one embodiment, the aggregated weighted contacts list 154 is created with each source Si being associated with a relative weight Wi, such that the sum of Wi=1. Suppose the values for the relationship between two contacts is Vi for Si. One way of aggregating the weights could be to compute the strength of the relationship between two contacts through the sum of Vi*Wi.

In the illustrated example, an aggregated relationship strength between contact x and contact a would be:

Vxa=(W1*v₁ₓₐ)+(W2*v₂ₓₐ)+(W3*v₃ₓₐ).

The Wi can be configured according to the extent to which the specific public source expresses a relationship. One could for example say that the relationship as expressed in blog comments is less significant than the relationship as expressed by paper co-authorship. Thus the weight of the paper source would get a higher Wi value than that of the blogging source.

This assumes that each source returns its weights in a normalized way, meaning that it describes the strength of a relationship relative to itself. So the strongest relationship should be 1 and the weakest 0. The configuration of the Wi can be user specific. A user can configure it according to the importance she attributes to her activity in a certain source. So if a person views paper-writing as her most important activity, she can set the Wi high relative to other sources, whereas if her activity in the blogging sphere is unimportant she can set the Wi low.

The described system includes a client system 160 with a local aggregator 161 local to the client system 160. The local aggregator 161 collects and aggregates client' social network data from private sources 170, 180 in the form of local client applications as well as from public sources 110-130 via the public aggregator 150. The local client applications may include: email applications; instant messaging applications; calendar and scheduling applications; address book application; and any other local application from which the user's social network data can be obtained.

The private sources 170, 180 contain information on a user's connections to other contacts. In the illustrated embodiment, private source 170 has user x 171 with connections to contacts a, b, c 172-174, and private source 180 has user x 181 with connections to contacts a, b 182-183. Connections can sometimes be directed, so user x may be connected to contact a who is not connected to user x.

As described for the public sources 110-130, users and contacts are usually a person, but as identities are defined electronically by users, it is possible that a user or a contact may be a group of more than one person. Conversely, a person may be represented by more than one contact. For example, a family may have a single entity as an email address, or a person may have more than one user identity.

Connections in private sources 170, 180 between the user and contacts may be unweighted and simply indicate a link between the user and contacts, or connections may have relationship weights or strengths. For example, a relationship strength is defined as vₛᵢⱼ for source s, for the connection from user i to contact j. It should be noted that relationship strengths can be directional, for example, vₛᵢⱼ does not have to be equal to vₛⱼᵢ.

The local aggregator 161 extracts for the user a weighted list 155, 156 of connected contacts out of each private source 170, 180. This can be done, for example, by keeping a list of relationships for the user. Each private source 170, 180 defines the strength of relationships of connected contacts according to its own semantics.

In general, the same factors as described above for public sources 110-130 can influence the weight computation for connections between contacts. For example, the number of email messages exchanged between the user and a contact, or the number of chat sessions directly between the user and a contact, or with the user and contact in a group session.

A private source's contacts' relationship strengths may be defined as vₛᵢⱼ for a relationship strength between user i and contact j at source s. In the illustrated example:
Private source 170 has relationship strengths for user x of: v₄ₓₐ, v_{4xb}, V_{4xc};
Private source 180 has relationship strengths for user x of: v₅ₓₐ, v_{5xb}.

The local aggregator 161 extracts the weighted lists 155, 156 of relationship strengths of connections for a user x from each private source 170, 180 and from a public aggregator 150. The public aggregator 150 provides an aggregated weighted contacts list 154 in the form an aggregation of relationship strengths of connections for the user x from multiple public sources.

The local aggregator 161 at the client system 160 creates an aggregated weighted contacts list 165 for the user with each private source SPi and the aggregated public sources SPui being associated with a relative weight Wi, such that the sum of Wi=1.

In the illustrated example, a result for x 162 as an aggregated relationship strength between user x and contact a would be:

Vxa=Wagg((W1*v₁ₓₐ)+(W2*v₂ₓₐ)+(W3*v₃ₓₐ))+(W4*v₄ₓₐ)+(iW5*v₅ₓₐ)

where Wagg is the weight of aggregated public sources and Wagg+W4+W5=1, and W1+W2+W3=1.

The Wi and Wagg can be configured by the user according to the extent to which the specific private and public sources express a relationship. The user may configure the aggregated weight for all public sources 110-130, or may configure the public sources 110-130 individually.

An example aggregation weighting scheme for social network information may look as follows. Each source gives a weight in [0,1] for a strength of relationship, where 0 stands for no relationship and 1 for the strongest relationship.

In an example, there are two private applications, email and chat, and two public applications, blogs and wikis. The desired aggregation would give email, blogs, chats, and wikis a relative importance of 1:2:3:4 respectively.

In this case, the local aggregator could be configured to consider email with a weight of 0.1, chat with a weight of 0.3, and the combined public data with a weight of 0.6. The public aggregator could be configured to aggregate blogs with a relative weight of 0.33′ and wikis with a relative weight of 0.66′.

Referring to FIG. 1B, an alternative embodiment of aggregation of data from public and private sources is shown in which data is gathered directly from public sources and private sources by a local aggregator 161 executing on the client system 160. The details described above in relation to FIG. 1A all apply to this embodiment without the separate public aggregation.

The local aggregator 161 extracts the weighted lists 151, 152, 153, 155, 156 of relationship strengths of connections for a user x from each public source 110, 120, 130, and each private source 170, 180. A result for x 162 as an aggregated relationship strength between user x and contact a would be:

Vxa=(W1*v₁ₓₐ)+(W2*v₂ₓₐ)+(W3*v₃ₓₐ)+(W4*v₄ₓₐ)+(W5*v₅ₓₐ)

where W1+W2+W3+W4+W5=1.

In a further alternative embodiment, there may be several layers of public and private aggregators, which aggregate data from different types, locations, access control levels, etc. until they are funneled into on final aggregator which is local to the user's machine in order to maintain privacy of the aggregated data. For example, an aggregator A1 could be provided that aggregates all the data from several social networks (for example, Facebook (Facebook is a trade mark of Facebook, Inc., or LinkedIn (LinkedIn is a trade mark of LinkedIn Corporation), etc.), another aggregator A2 could be provided that aggregates all the data from blogging sites, etc., then a super-aggregator could be provided that aggregates the results from A1, A2 . . . An, and in turn this data could be received at the local system and merged with the private data.

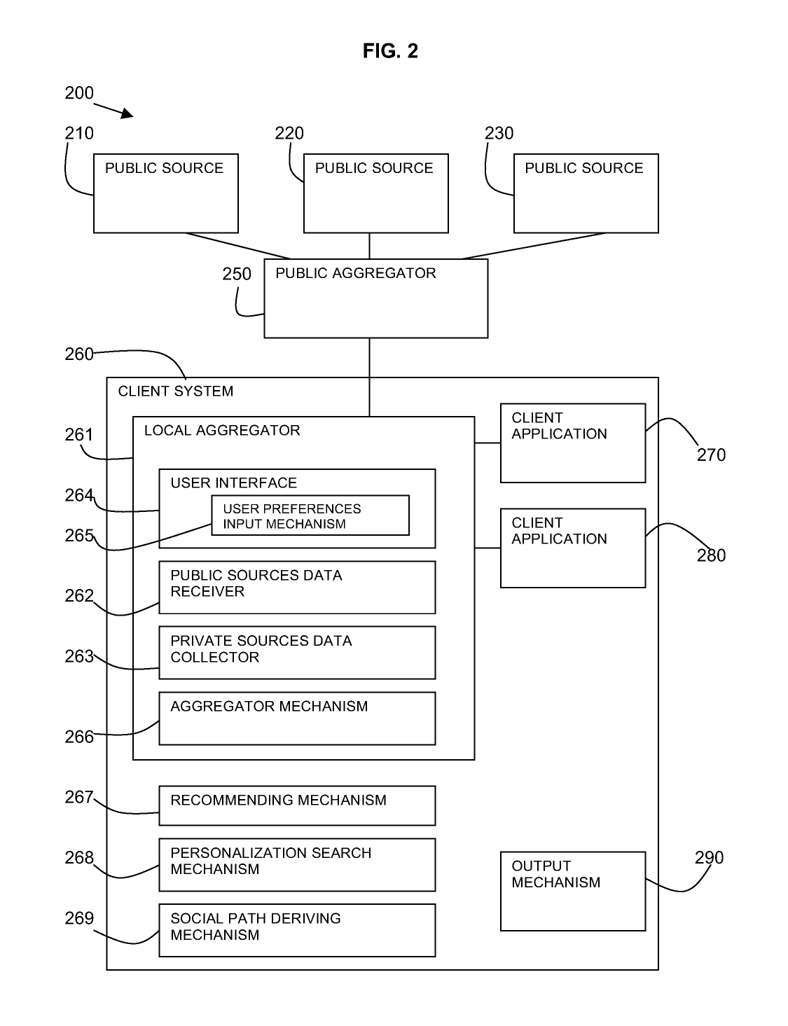

Referring to FIG. 2, a block diagram shows an example of the described system 200. A client system 260 includes client applications 270, 280 which generate social network information relating to a user of the client system 260. For example, the client applications 270, 280 may be an email application and an instant messaging or chat application. The client applications 270, 280 store their data on the client system 260 and due to privacy requirements, this data should not be made public via an external network.

The client system 260 includes a local aggregator 261, for aggregating social network data relating to a user. The aggregated social network data for a user can be applied in many ways to improve a user experience as described further below. The local aggregator 261 obtains social network data relating to a user from the client applications 270, 280.

In addition, the local aggregator 261 obtains public social network data relating to the user from public sources 210-230 via a network. The data from the public sources 210-230 may be aggregated by a public aggregator 250 or directly collected by the private local aggregator 261 when required for a user. A public aggregator 250 may be for example, SOcial Networking ARchitecture (“SONAR”) (see reference “Harvesting with SONAR—The Value of Aggregating Social Network Information” I. Guy, M. Jacovi, E. Shahar, N. Meshulam, V. Soroka, S. Farrell, In proc. of CHI 2008).

The social network data from the private sources 270, 280 and directly from public sources 210, 220, 230 is aggregated by the local aggregator 261 with weightings for the importance of data from each source 210, 220, 230, 270, 280. In an embodiment in which social network data from public sources 210-230 has already been aggregated by the public aggregator 250, the aggregated data is combined in the local aggregator 261 with a weighting for the aggregated public data.

A social network architecture application programming interface (API) is provided for sharing social network data and aggregating it across sources 210-230, 270, 280 to show who is related to whom and how.

Public sources 210-230 and private sources 270, 280 implement the API to provide internal information about how strongly people are connected and by what means. The local aggregator 261 can use the API to access data from a single source that implements the API or from a public aggregator with the API, to consolidate the data from different public sources. This way, a user of the local aggregator 261 can choose multiple private 270, 280 and public sources 210-230 and assign an appropriate weight to each of them.

The first premise behind the described social network API is that it is necessary to present the strength of ties between people. In contrast to APIs for specific social network applications (for example, like Facebook), the described system does not model any specific semantics of the underlying system like “friending” or “communities”. Instead, it asks sources to boil down these semantics into floating point numbers between 0 and 1.

The public aggregator 250 and local aggregator 261 combine results from multiple sources using a simple weighted average. This approach enables diverse applications from instant messaging clients through publication databases to social network sites to provide data supporting an aggregated view of relationships among contacts. The user is oblivious to the types of relations—when querying for strength of a relationship, all that the user sees is contacts and the weight of their associations.

The local aggregator 261 includes a public sources data receiver 262 which may obtain the public sources data from a public aggregator or direct from public sources. The local aggregator 261 includes a private sources data collector 263 for obtaining private social network data from private sources local to the local aggregator 261.

The local aggregator 261 includes a user interface 264 for inputting a request for information relating to a user. There may be more than one user who uses the client system 260 with appropriate password log-on restrictions to access of information between the users.

The user interface 264 also includes a user preferences input mechanism 265 for inputting weightings for different sources of data. The user interface 264 of the local aggregator 261 may include a preference page in which the user may choose the relative weight of each data private source and the aggregated public sources. The user interface 264 may include modifying the weight combinations of different sources by sliders. When adjusting the preferences, the user may see a preview of the results. This enables fine tuning the selection of weights.

An aggregator mechanism 266 is provided which calculates the aggregated social network data for a user in the form of user relationships to contacts. When a request is received for user's social network data, the aggregator mechanism 266 forwards it to each private source 270, 280 and either to public sources 210-230 or to the public aggregator 250. The call to request data can specify the configuration of weights for this specific call. The public sources data receiver 262 and the private sources data collector 263 receive the responses to the requests. The aggregator mechanism 266 then processes the results by extracting lists of contacts connected to the user and aggregates the lists of contacts from different sources computing a weighted average and returns the result to the user via an output in the user interface 264.

For the email information, the aggregator's user interface 264 requests the user's password and then crawls the mailbox and collects details of people the user corresponds with.

In instant messaging, social information is extracted from the history of chat transcripts, as these indicate the people a person actually chats with.

In an internal organization application of the described system, the user and contacts have organizational identifiers. The system can be applied outside an organization by using a system for mapping and sharing unique user IDs.

An output mechanism 290 provides an output in the form of aggregated social network data for a user which may be applied by a client system in various applications.

The local aggregator 261 may include or send social network data for a user to one of the following components.
A recommending mechanism 267 for recommending contacts for the user to connect or recommending content for the user based on the combined private and public social network data for the user.
A personalizing search mechanism 268 for personalizing a search for the user based on the combined private and public social network data for the user.
A social path deriving mechanism 269 for deriving social paths from the user to a contact to which she is not directly connected, based on the combined private and public social network data for the user.

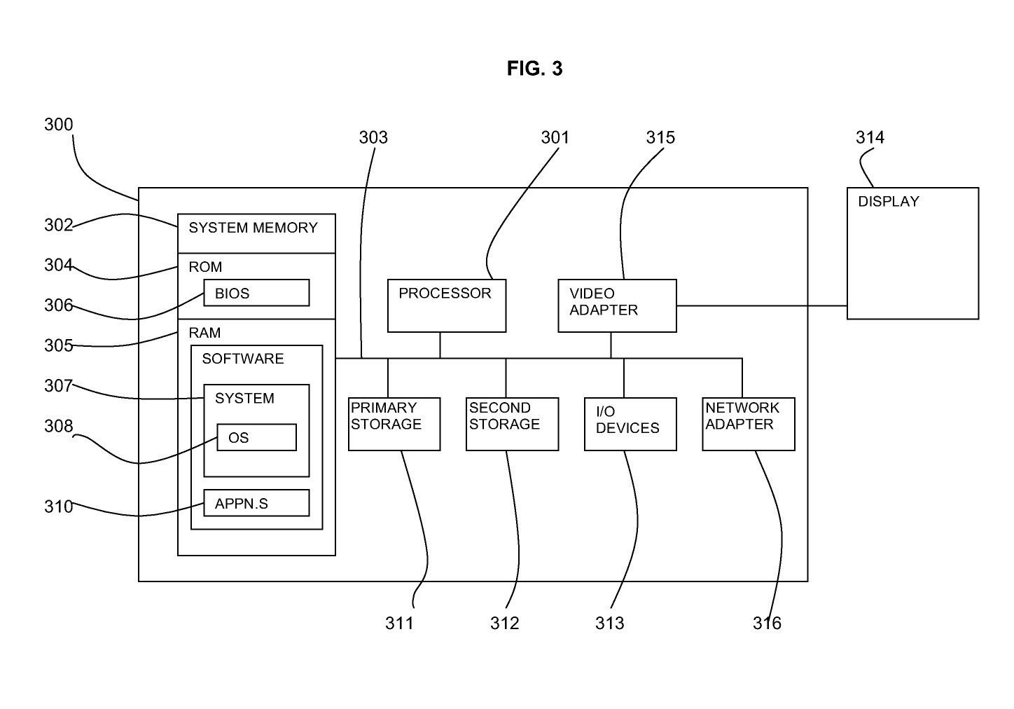

Referring to FIG. 3, an exemplary system for implementing a client system with a local aggregator includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

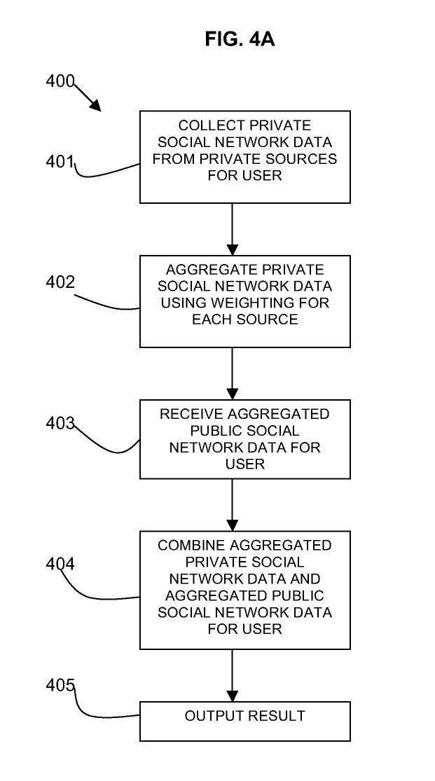

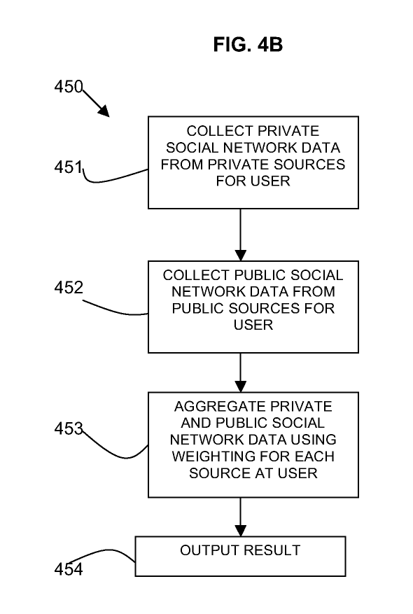

Referring to FIGS. 4A and 4B, flow diagrams 400, 450 show methods at a local aggregator on a client system.

In FIG. 4A, the local aggregator collects 401 private social network data from private sources local to the client system for a user. The social network data for a user takes the form of a list of contacts of the user with an optional relationship weight between each contact and the user. The local aggregator aggregates 402 the private social network data from different private sources using a weighting for each source.

The local aggregator collects 403 aggregated public social network data from a public aggregator for a user. The public social network data for a user is a list of contacts of the user with optional relationship weights between each contact and the user. The aggregated public social network data is compiled from various public sources each with a weighting.

The local aggregator combines 404 for a user the private social network data from private sources with the aggregated public social network data using the weightings of the private sources and an overall weighting of the aggregated public sources. The result is output 405 for use by user.

In FIG. 4B, the local aggregator collects 451 private social network data from private sources for a user and collects 452 public social network data from public sources for the user. The local aggregator aggregates 453 the private and public social network data using weightings for each source. The result is output 454 for use by the user.

The described methods preserve the privacy model of each of the private sources, email and chat, as personal sources are only accessible to the owning user, while blogs and wikis, which are public, are accessible to all users.

The described method enriches a public social network (which is accessible to all) with private information to create a more comprehensive social network for a specific user, without infringing the privacy level as determined by the private data sources. The sociocentric network as reflected in public sources can be aggregated with the egocentric network as reflected in personal sources to create one richer network for the user. The enrichment only occurs to the user's egocentric network and the egocentric information will only be accessible for the user and will not be exposed to other users, hence keeping the original privacy level of this data.

Enriching the egocentric network, as reflected in personal sources, with information from public sources, opens up new opportunities for learning about a user's extended network (i.e. user's connections and their connections with others). Consider, for example, Alice who seeks a social connection to Cindy. Cindy may not appear at all in Alice's egocentric network based on personal sources. However, examining the extended network, Alice may discover that Bob—who appears on her egocentric network by her personal data—is related to Cindy according to public sources. Alice will then be able to discover a social path to Cindy through Bob, based on aggregation of her personal and public sources.

The enrichment of public social network information with private information can be useful in various applications including the following.
Recommending people for a user to connect to. Recommendation based on only a public network is known and this could be enriched by the user's egocentric network data. In such a case, a person could be recommended to the user, for example, based on 3 shared wikis [public], 1 shared paper [public], 25 exchanged email messages [private], and 5 joint IM conversations [private].
Content recommendation based on the user's network. Recommendations would include content connected to contacts with which, for example, the user has had IM conversations [private], as well as content connected to contacts with which the user has published papers [public].
Personalized search based on the user's network. Search results related to contacts connected to the user (through, for example, exchanged email messages [private], shared meetings in the addressbook [private], co-authoring a patent [public], or commenting on the same blog [public]) are shown first in the list.
Deriving social paths from one person to another—finding a route from person a to person b, composed of persons p₁ to pₙ, where person a is connected to p₁, person p₁ to person p₂, etc., and person pₙ is connected to person b. In this case, the private data is only useful for the first edge of the path—the connection from the user to another person. The rest of the path can be composed from the sociocentric network, i.e., from public data.

A social network weighting system may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for aggregation of social network data, comprising:
collecting private social network data relating to a user from applications on a user's local system;
receiving public social network data at the user's local system; and
combining the private social network data with the public social network data on the user's local system;
wherein the combined private and public social network data is only accessible by or with the permission of the user on the user's local system;
wherein said steps are implemented in either:
a) computer hardware configured to perform said identifying, tracing, and providing steps, or
b) computer software embodied in a non-transitory, tangible, computer-readable storage medium.

2. The method as claimed in claim 1, wherein the private social network data relating to a user includes relationships between the user and other contacts.

3. The method as claimed in claim 1, wherein receiving public social network data receives aggregated public social network data relating to the user from a server system, wherein the aggregated public social network data is collected from public sources.

4. The method as claimed in claim 1, including weighting private social network data from each of the applications.

5. The method as claimed in claim 1, including weighting the received public social network data.

6. The method as claimed in claim 3, including weighting the public social network data from each of the public sources.

7. The method as claimed in claim 4, wherein weightings are set by the user.

8. The method as claimed in claim 1, wherein public social network data for a user is enriched locally at a user's system with private social network data for the user.

9. The method as claimed in claim 1, wherein the applications local to the user's system include one or more of the group of: email applications, instant messaging applications, calendar or scheduling applications; address book applications; and other applications including contact information.

10. The method as claimed in claim 3, wherein the public sources include one or more of the group of: web logs; content sharing websites (wikis); friending applications; social tagging networks; social network services; publication or patent repositories; organizational charts; and other sources in which users' interact.

11. The method as claimed in claim 1, wherein social network data is influenced by one or more of the group of: number of common interactions between contacts; number of total interaction of each contact; number of participants in each interaction; time span of interaction; time passed since interaction; symmetry of interaction; reciprocity of interaction;
and sentiment of interaction.

12. The method as claimed in claim 1, including recommending contacts for the user to connect to based on the combined private and public social network data for the user.

13. The method as claimed in claim 1, including recommending content for the user based on the combined private and public social network data for the user.

14. The method as claimed in claim 1, including personalizing search for the user based on the combined private and public social network data for the user.

15. The method as claimed in claim 1, including deriving social paths for the user based on the combined private and public social network data for the user.

16. A computer program product for aggregation of social network data, the computer program product comprising:
a computer readable storage medium having computer readable program code embodied therewith, the computer readable program code comprising:
computer readable program code configured to:
collect private social network data relating to a user from applications on a user's local system;
receive public social network data at the user's local system; and
combine the private social network data with the public social network data on the user's local system;
wherein the combined private and public social network data is only accessible by or with the permission of the user on the user's local system.

17. A system for aggregation of social network data on a user's local system, comprising:
a processor;
a private social network data collector for collecting private social network data relating to a user from applications on a user's local system;
a receiver for receiving public social network data at the user's local system;
a local aggregator for combining the private social network data with the public social network data on the user's local system;
wherein the combined private and public social network data is only accessible by or with the permission of the user on the user's local system.

18. The system as claimed in claim 17, wherein the receiver receives aggregated public social network data relating to the user from a public aggregator on a server system, wherein the aggregated public social network data is collected from public sources.

19. The system as claimed in claim 17, wherein the local aggregator weights private social network data from each of the applications.

20. The system as claimed in claim 17, wherein the local aggregator weights the received aggregated public social network data.

21. The system as claimed in claim 17, including a user interface with an input mechanism for user preferences of weightings.

22. The system as claimed in claim 17, wherein the applications local to the user's system include one or more of the group of: email applications, instant messaging applications, calendar or scheduling applications; address book applications; and other applications including contact information.

23. The system as claimed in claim 17, including a recommending mechanism for recommending contacts for the user to connect or recommending content for the user based on the combined private and public social network data for the user.

24. The system as claimed in claim 17, including a personalizing search mechanism for personalizing a search for the user based on the combined private and public social network data for the user.

25. The system as claimed in claim 11, including a social path deriving mechanism for deriving social paths for the user based on the combined private and public social network data for the user.
